(19) United States
(12) Patent Application Publication
(10) Pub. No.: US 2009/0052783 A1
(43) Pub. Date: Feb. 26, 2009

(54) SIMILAR SHOT DETECTING APPARATUS, COMPUTER PROGRAM PRODUCT, AND SIMILAR SHOT DETECTING METHOD

(75) Inventors: Hisashi AOKI, Kanagawa (JP); Koji YAMAMOTO, Tokyo (JP); Osamu YAMAGUCHI, Kanagawa (JP); Kenichi TABE, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/050,588

(22) Filed: Mar. 18, 2008

(30) Foreign Application Priority Data
Aug. 21, 2007 (JP) 2007-215143

(51) Int. Cl. G06K 9/62

(52) U.S. Cl. 382/209

(57) ABSTRACT

If a difference between feature values of frames from different shots is within a predetermined error range, one or more target frames are selected from each of the shots. Based on face areas in the selected target frames, the feature values of the target frames are calculated. If a difference between the feature values of the target frames is within a predetermined error range, these shots, from which these similar frames are originally retrieved, are assigned with the same shot attribute and set to be similar shots.

### CROSS-REFERENCE TO RELATED APPLICATIONS

This application is based upon and claims the benefit of priority from the prior Japanese Patent Application No. 2007-215143, filed on Aug. 21, 2007; the entire contents of which are incorporated herein by reference.

### BACKGROUND OF THE INVENTION

1. Field of the Invention

The present invention relates to a similar shot detecting apparatus, a computer program product, and a method that detect similar shots taken from the same camera angle.

2. Description of the Related Art

A program recording apparatus that has been recently developed can identify a person in a video, and use the identification for retrieval.

Such a program recording apparatus identifies two shots taken from the same camera angle (that is, detects similar shots), and inspects the similarity between these shots by comparing feature values thereof, such as hue histograms, that are independent from subjects in the shots. In this manner, similar shots can be retrieved, and the shots can be divided along the time-line in the manner suitable for the contents. For example, a moving image processing method disclosed in the JP-A H9-270006 (KOKAI), can classify a pair of videos or video segments (shots) at a high speed with a small computing load. According to this method, an image feature value (e.g., hue histogram), which is small in data size, is obtained from an entire screen, and similarity between the entire screens is inspected based on the obtained image feature values. These videos or video segments are classified, assigned with attributes, and are associated with each other based on the similarity.

However, this method for detecting similar shots, disclosed in the JP-A H9-270006 (KOKAI), has a problem. For example, if a person moves or a camera work is changed, such as by zooming in, between the pair of images, having the image feature values to be compared, videos or video segments that should be detected as being similar sometimes are not detected correctly, and sufficient detection accuracy cannot be achieved, although the shots may be taken from the same camera angle.

### SUMMARY OF THE INVENTION

According to one aspect of the present invention, a similar shot detecting apparatus for a video component includes a frame selecting unit that selects one or more target frames from each of shots that are aggregates of frames within a time period divided by a cut point corresponding to a switching of video shooting within the temporally consecutive frames, when a difference between feature values of the target frames is within a predetermined error range; a feature value calculating unit for detecting similar shots that calculates a feature value of each of the target frames, based on face areas within each of the target frames; a feature value comparing unit that compares the feature value for each of the target frames calculated by the feature value calculating unit; and a shot attribute assigning unit that assigns a same shot attribute to each of the shots from which the target frames determined to be similar are retrieved, thereby making each of the shots as a similar shot, when a difference between the feature values of the target frames is within a predetermined error range.

According to another aspect of the present invention, a similar shot within a video component detecting method includes selecting one or more target frames from each of shots that are aggregates of frames within a time period divided by a cut point corresponding to a switching of video shooting within the temporally consecutive frames, when a difference between feature values of the target frames is within a predetermined error range; calculating a feature value of each of the target frames based on face areas within each of the target frames; comparing the feature value for each of the target frames; and assigning a same shot attribute to each of the shots from which the target frames determined to be similar are retrieved, when a difference between the feature values of the target frames is within a predetermined error range.

A computer program product according to still another aspect of the present invention causes a computer to perform the method according to the present invention.

### BRIEF DESCRIPTION OF THE DRAWINGS

FIG. 1 is a block diagram of a configuration of a video processing apparatus according to an embodiment of the present invention;

FIG. 2 is a block diagram illustrating a schematic constitution of the video processing apparatus;

FIG. 3 is a schematic diagram of an example of face area tracking;

FIG. 4 is a schematic diagram of an example of area tracking taking a passing movement into account;

FIG. 5 is a functional block diagram of a similar shot detecting unit shown in FIG. 2;

FIG. 6 is a schematic diagram of an example of how a feature value calculation area is determined;

FIG. 7 is a schematic diagram of another example of how a feature value calculation area is determined;

FIG. 8 is a schematic diagram of still another example of how a feature value calculation area is determined;

FIG. 9 is a schematic diagram of an example of a face area detecting method;

FIG. 10 is a schematic diagram of another example of the face area detecting method;

FIG. 11 is a flowchart of a face attribute assignment;

FIG. 12 is a schematic diagram of an example of the face attribute assignment; and

FIG. 13 is a schematic diagram of an example of a face attribute correction.

### DETAILED DESCRIPTION OF THE INVENTION

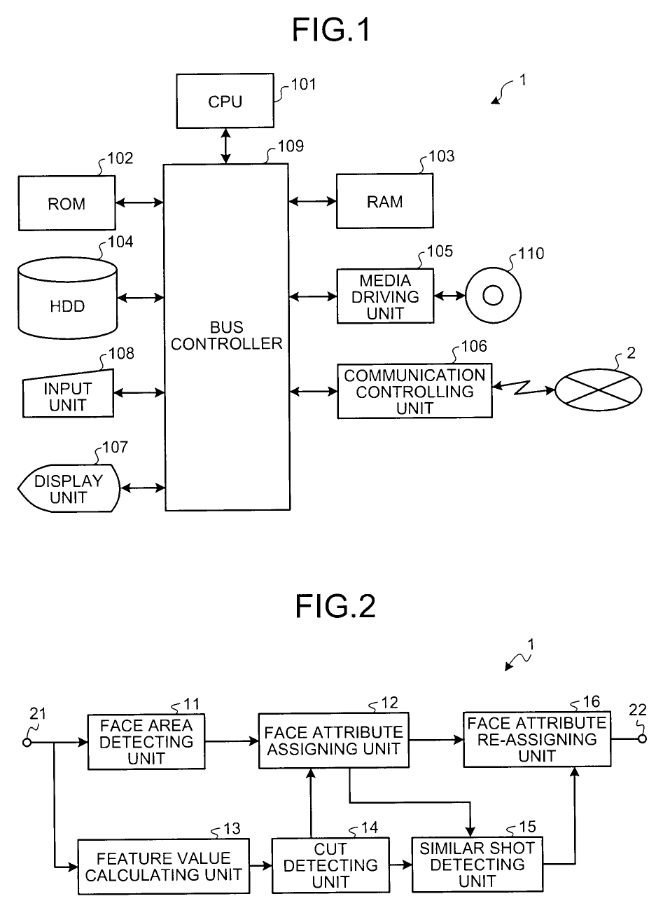

An embodiment of the present invention is explained with reference to FIGS. 1 to 13. In this embodiment, a personal computer is applied as a video processing apparatus (similar shot detecting apparatus).

FIG. 1 is a block diagram of a video processing apparatus 1 according to the embodiment of the present invention. The video processing apparatus 1 includes a central processing unit (CPU) 101 that processes information, a read-only memory (ROM) 102 that stores therein programs such as BIOS, a random access memory (RAM) 103 that stores therein various data in a writable manner, a hard disk drive (HDD) 104 that functions as various databases and stores therein various programs, a media driving unit 105 such as a digital versatile disk (DVD) drive, a communication controlling unit 106, a display unit 107 such as a liquid crystal display (LCD), and an input unit 108 such as a keyboard or a mouse. The media driving unit 105 functions to store information in a storage medium 110, distribute information externally, and obtain external information. The communication controlling unit 106 exchanges information with an external computer by way of communications over a network 2. The display unit 107 displays, for example, a progress or a result of a process for a user. The input unit 108 is operated by the user upon inputting an instruction or information to the CPU 101. A bus controller 109 arbitrates data transmission and reception among these elements.

When the user powers on the video processing apparatus 1, the CPU 101 initiates a program called a loader from the ROM 102 to read an operating system (OS), which is a program that manages hardware and software of the computer, from the HDD 104 into the RAM 103, and starts up the OS. The OS functions to start up a program, read information, and store therein based on the user operations. One of known major OSes is Windows (registered trademark). An operation program that runs on an OS is called an “application program”. However, an application program is not limited to one that runs on a given OS, but includes a program that causes the OS to execute some parts of various processes thereof, which are to be described later, on behalf of the application program itself. Alternatively, an application program may be included in a set of program files of a given application software or an OS.

The video processing apparatus 1 includes a video processing program, as an application program, stored in the HDD 104. In this context, the HDD 104 functions as a storage medium that stores therein the video processing program.

Generally, the application programs to be installed in the HDD 104 of the video processing apparatus 1 are stored in the storage medium 110. The storage medium 110 includes an optical disk such as a DVD, various magneto-optical disks, various magnetic disks such as a flexible disk, and various types of media such as semiconductor memories. The operation program stored in the storage medium 110 is installed onto the HDD 104. Therefore, the storage medium 110 having portability, such as optical storage media, e.g., a DVD, or a magnetic medium, e.g., a diskette (i.e., floppy disk, FD), can also be a storage medium for storing an application program. Furthermore, the application programs can also be obtained by the communication controlling unit 106 via the external network 2, and installed onto the HDD 104.

When a video processing program that operates on the OS is started up, the CPU 101 executes various computing processes following the video processing program to centrally control each of the units included in the video processing apparatus 1. Computation processes executed by the CPU 101 in the video processing apparatus 1 and characterizing the present invention will be now explained.

FIG. 2 is a block diagram illustrating a schematic constitution of the video processing apparatus 1. As shown in FIG. 2, the video processing apparatus 1 follows the video processing program and includes a face area detecting unit 11, a face attribute assigning unit 12, a feature value calculating unit 13, a cut detecting unit 14, a similar shot detecting unit 15, and a face attribute re-assigning unit 16. A reference number 21 denotes to a video input terminal, and a reference number 22 denotes to an attribute information output terminal.

The face area detecting unit 11 detects an area that is presumed to be the face of a person (hereinafter, “face area”) from a still image input from the video input terminal 21. The still image can be either a single image, such as a photograph, or one of many that make up a moving image when correlated with a playback time (a frame). To check the presence of the area that is presumed to be a face, or to identify the image thereof, for example, the method disclosed in Mita et, al. “Joint Haar-like Features for Face Detection” (Proceedings of the Tenth IEEE International Conference on Computer Vision (ICCV '05), 2005) can be used. However, a method for detecting the face area is not limited to the above, and other methods can be also used.

The face attribute assigning unit 12 keeps track of a set of coordinates corresponding to the face area that is detected by the face area detecting unit 11, to see whether the coordinates of face areas in two frames can be considered identical, that is, the difference thereof is within a predetermined error range.

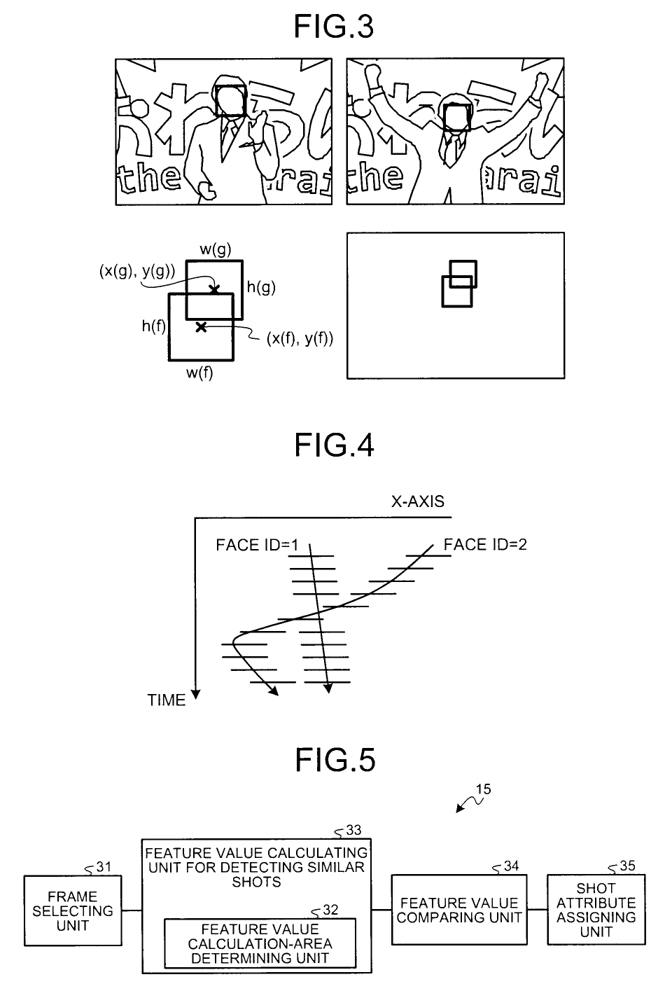

FIG. 3 is a schematic diagram of an example of a face area tracking. In FIG. 3, it is assumed that Nᵢ face areas are detected from the ith frame in a moving image. The set of the face areas detected from the ith frame is denoted as Fᵢ. The Fᵢ is expressed as a rectangular area having coordinates (x, y) at a center, a width (w), and a height (h). A set of coordinates corresponding to the jth face area in the ith frame are expressed as x(f), y(f), w(f), and h(f), where f is an element of the set Fᵢ (fεFᵢ). To keep track of a face area, for example, the following conditions are used. That is, “change of the center coordinates is within a distance dc in the two frames”, “change of the width is within dw”, and “change of the height is within dh”. If each of “(x(f)−x(g))²+(y(f)−y(g))²≦dc²”, “|w(f)−w(g)|≦dw”, and “|h(f)−h(g)|≦dh” is established, the face areas f and g are presumed to be the face of a same person. The symbols “| . . . |” indicates an absolute value. The calculations are performed for every face area f that is fεFᵢ, and every face area g that is gεFⱼ.

However, a method for tracking the face area is not limited to the one described above, and other methods may be also used. For example, in a scene where another person walks across a person over the camera, the face area tracking method can cause a detection error. To solve such a problem, as shown in FIG. 4, the face area may be tracked by making an inference about the trend of a movement of each face area, based on information of frames that are two frames before the tracking frame, taking such a movement going across the camera into consideration (occlusion).

Furthermore, in the face area tracking method, the rectangular area is used for the face area. However, other shapes of areas, such as a polygon or an oval, may be also used.

When the pair of face areas are presumed to be the face of the same person from the two different frames, the same face attribute (ID) is assigned to that pair of face areas.

The feature value calculating unit 13 calculates a feature value of a frame input via the video input terminal 21 without performing any understanding process of the content structure thereof (e.g., detecting a face or an object). The calculated amount is used by the cut detecting unit 14 to detect a cut by at a later stage. The input frame could be a single still image, such as a photograph, or one of many that make up a moving image when correlated with a playback time (a frame). Examples of the feature value of a frame include brightness of pixels or an average of colors included in the frame, histograms thereof, or an optical flow (movement vector) in the entire screen or in a smaller area obtained by mechanically segmenting the entire screen.

The cut detecting unit 14 uses the feature value calculated by the feature value calculating unit 13 to detect a cut. A cut is a point where one or more of the feature values changes greatly in consecutive frames. If a cut is detected, it means that a camera is switched to another within two temporally continuing frames. The cut detection is sometimes referred to also as “scene change detection”. In a television broadcasting context, a “cut” indicates a moment at which a camera, which is shooting an image to send out over a broadcasting wave, is switched to another, a moment at which an image shot by a camera is switched to a pre-recorded video, or a moment at which two different pre-recorded videos are connected temporally by editing. For artificial video production using computer graphics (CG) or animation, a switching point, provided under the same intention as that of video production with the natural image, is referred to as a “cut”. According to this embodiment, such a moment at which the image is switched to another is referred to as a “cut” or a “cutting point”, and a video lasting a given time period and is delimited by cuts is called a “shot”.

Many proposals for the cut detecting methods have been developed. For example, a method is disclosed in: Nagasaka, et al, “VIDEO SAKUHIN NO BAMEN GAWARI NO JIDO HANBETSU HOU” (“Automatic scene-change detection method for video works”), Information Processing Society of Japan, The 40th National Convention of IPSJ, Paper Collection, pp. 642-643, 1990. However, the cut detection method is not limited to those above, and other methods can also be used.

A cut point that is detected by the cut detection unit 14 is sent to the face attribute assigning unit 12, and a shot that is a video segment divided by the cut detection unit 14 along the time-line is sent to the similar shot detecting unit 15.

If the face attribute assigning unit 12 determines that the cut point, sent from the cut detecting unit 14, is between the two frames that are now being tracked, the face attribute assigning unit 12 stops keeping track of the face area, and determines that these two frames do not have any pair of face areas that the same attribute should be assigned.

The similar shot detecting unit 15 detects similar shots from the shots sent from the cut detecting unit 14. A shot lasts for a shorter period than a “situation” or a “scene” such as “a detective tracks down a criminal to a warehouse at a port”, or “a contestant answers the first question of a quiz within a time limit”, for example. A situation, a scene, or a program segment is made from a plurality of shots. However, if shots are taken from the same camera, similar images are displayed on a screen. Even if the shots are separated temporally, as long as a “camera angle”, such as a position of the camera, a degree of zooming (close up), or a direction of shooting, does not change greatly, the screen displays similar images. In this embodiment, these similar images are called “similar shots”. For artificial video production using CG or animation, the shots composed as if an object is shot from the same angle, under the same productive intention, can be also referred to as “similar shots”.

The similar shot detection performed by the similar shot detecting unit 15 will be now explained in detail. The similar shot detecting unit 15 according to this embodiment composes a result of face detection with a result of cut detection to detect the similar shots.

FIG. 5 is a functional block diagram of the similar shot detecting unit 15. As shown in FIG. 5, the similar shot detecting unit 15 includes a frame selecting unit 31, a feature value calculating unit 33 for detecting similar shots, a feature value comparing unit 34, and a shot attribute assigning unit 35. The feature value calculating unit 33 further includes a feature value calculation-area determining unit 32.

The frame selecting unit 31 selects one or more still image from the two shots whose similarity are to be determined. A still image can be selected from a given position such as a front end, a middle, or a rear end of each shot, or several images may be also selected from the front end or the rear end, and so on.

The feature value calculation-area determining unit 32 determines a feature value calculation area, which is to be used in the feature value calculating unit 33 at a later stage, based on a face area that is the result of the face detection and the face tracking performed by the face area detecting unit 11 and the face attribute assigning unit 12, respectively, for all frames included in the moving image.

It will now be explained in detail how the feature value calculation area is determined in a frame.

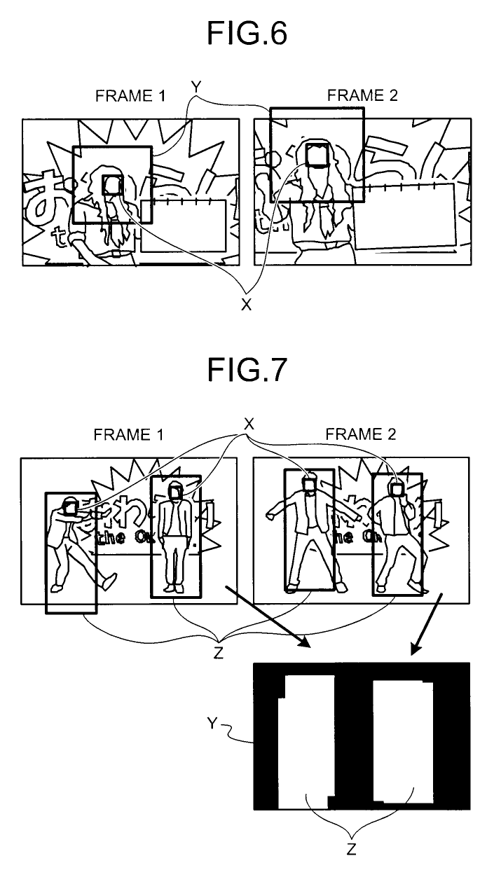

As shown in FIG. 6, it is assumed that a face area X has been detected in each of the frames whose similarity is to be compared. To obtain an area Y to calculate the feature value, the face area X, belonging to each frame, is extended by performing a given calculation to the set of coordinates that represent the face area X. An example of such given calculation is keeping the face area X and the center coordinates as they are, and multiplying the width and the height thereof by a given constant to obtain a feature value calculation area Y. This method reduces the risk of images being judged not similar despite the camera is simply zoomed in as shown in FIG. 6, pushing out the pixels at the peripheries of the image from the screen, thus being excluded from the image feature value of the entire screen. By reducing such risk, similar shots can be detected more accurately as a result.

Another example of the calculation for determining the feature value calculation area Y is explained with reference to FIG. 7. Assuming that, as shown in FIG. 7, a face area X has been detected in each of the frames whose similarity is to be compared, each of the face areas X is extended by performing a given calculation to the coordinates of the face area X, and the resultant extended areas are combined (summed up) to create a composite area (people area) Z. Then, the composite area Z is subtracted from the two frames to obtain the feature value calculating area Y. An example of such given calculation is to bring down the center of the face area X by a length obtained by multiplying the height of the face area X by a constant, and to multiply the width and the height thereof by a given constant, and the resultant area is excluded from feature value calculation area Y. The composite area Z is intended to include the people on the screen in an averaged manner with reference to the position or the size of the faces. This method reduces the risk of shots being determined not similar when the camera angle has not changed but the position of the people changed greatly, because it is determined based on the image feature values generated by the pixels of a background that has been hidden but later became shown, or a background that has been shown but later became hidden. By reducing such a risk, similar shots can be detected more accurately as a result.

Still another example of a calculation to determine the feature value calculation area Y is, assuming that a face area X has been detected in each of the frames whose similarity is to be compared, the coordinates of the face area X themselves can be used as a part or all of the feature value calculated by the feature value calculating unit 33 (in this example, the feature value calculation-area determining unit 32 does not need to be operated). For example, assuming that there are more than one face areas in each of the frames, the set of the coordinates (x, y, w, h) of the face areas, such as those exemplified above for the first embodiment, may be added as the orders of characterizing vectors formed from each component of a hue histogram that is calculated from the entire frame (for the calculation method, see JP-A H9-270006 (KOKAI), for example).

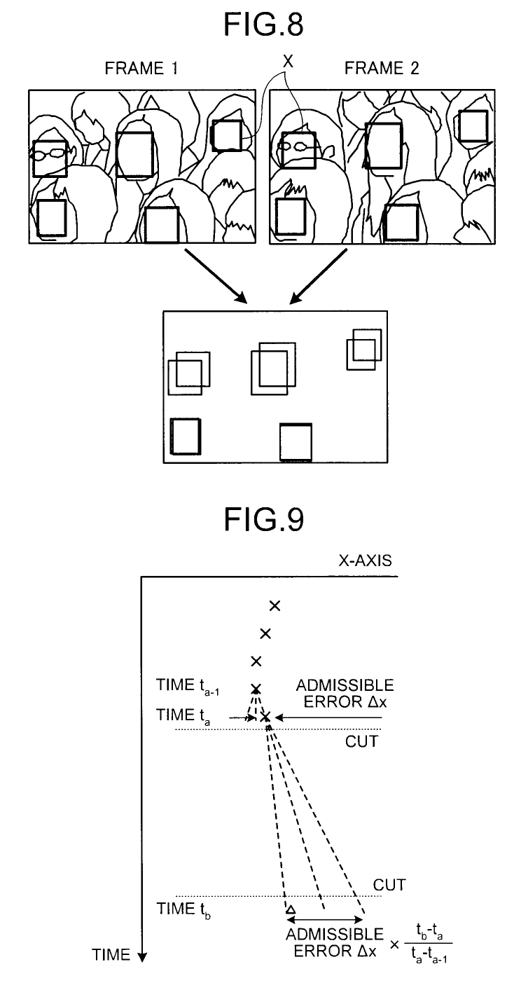

Similar shot detections may also be performed by using only the coordinates of the face areas, without using the image feature value calculated from the entire frame. For example, as shown in FIG. 8, if a plurality of people are captured in different shots and the position or the size of none of the people are determined to be changed in completely different directions (that is, changes in their face areas X are very small), these two frames can be determined to be taken from the same camera angle. In other words, the shots created from these two frames can be determined to be similar.

The feature value calculating unit 33 for detecting similar shots calculates a feature value of a frame based on the limited area determined by the calculation area determining unit 32. Examples of the feature value include brightness of pixels or an average of colors included in the frame, histograms thereof, or an optical flow (movement vector) in the entire image or in a smaller area obtained by mechanically segmenting the screen.

The feature value comparing unit 34 compares the feature values calculated for the two frames.

If the feature value comparing unit 34 determines that the frames are similar, the shot attribute assigning unit 35 assigns the same shot attribute (ID) to the shots that created the frames that are determined similar.

In this manner, the similar shot detecting unit 15 detects similar shots from the shots that are videos segmented along the time-line sent from the cut detecting unit 14.

After the face area detecting unit 11 and the face attribute assigning unit 12 have completed the face detection and the face tracking of all frames in the moving image, and the similar shot detecting unit 15 has completed detection of all similar shots, the face attribute re-assigning unit 16 determines if any of the face areas that are in different shots and assigned with different face attributes should be considered to be the face of a same person. This process is performed for the following reason. The face attribute assigning unit 12 determines that it is the same person based on the location thereof that is close in coordinates and also temporally consecutive. The face attribute assigning unit 12 cannot keep track of face areas that are temporally separated in the moving image. Therefore, relying on the process up to this point, it is not possible to assign the same face attributes to such face areas, even if these face areas actually are the images of the face of the same person.

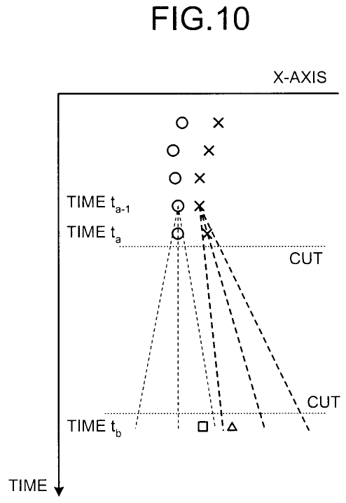

Now, it will be explained how the face attribute re-assigning unit 16 detects the face areas with reference to FIGS. 9 and 10. The face attribute re-assigning unit 16 can detect a face area in the same manner as the face attribute assigning unit 12. As shown in FIG. 9, the face area detected in the former frame (at time tₐ₋₁) (as marked by a x) is considered to be near the face area detected in the next frame (at time t_{d}) (as marked by another x) in two frames temporally continuing, that is, these detected face areas represent the face of the same person, if the following condition is met. The center of the face area at the time tₐ is in within a radius of Δx with the center of the face area xₐ₋₁ (x is a vector in the xy coordinate) at time tₐ₋₁. It is assumed that another face is detected at a time t_{b} (marked as a Δ) in a shot that is temporally separated but determined to be similar to the shot including the frames at the times tₐ₋₁ and tₐ. Such a face can be determined to be the same face as that has been detected and represented by the x, if the following condition is met. The face area (as marked by the Δ) is in a radius kΔx with the center xₐ+k(xₐ−xₐ₋₁), where the coefficient k is k=(t_{b}−tₐ)/(tₐ−tₐ₋₁).

FIG. 10 is a diagram of an example of the face tracking when a plurality of faces are detected. As shown in FIG. 10, in two shots that are determined similar, two face areas represented by “O” and “x” are detected in the former shot, and two face areas represented by “Δ” and [symbol] are detected at the beginning of the latter shot. These face areas are mapped, for example, in the manner described below. To keep track of the face area “x”, the central position xₐ+k(xₐ−xₐ₋₁) of the area “x” at the time t_{b} is obtained in the same way as described above. Upon doing so, a normal probability distribution with a half width of kΔx is used. The kΔx is predetermined value, which is the same as described above. When the probability distribution of the position “Δ” is calculated, the value generated for the area “x” is higher than that for the area “O”. As a result, it can be assumed that the area “Δ” is the same person as the area “x”. The same can be said to the areas “O” and [symbol] .

As explained above, in this embodiment, the face areas in frames that are temporally separated, that is, in shots, can be matched as long as two shots are known to be similar. The face areas can be matched by multiplying the radius thereof by a threshold value (Δx in this example), used for the face tracking performed per frame, that is dependent on the temporal distance between the former and the latter shots.

While comparing sets of coordinates representing face areas, the sets of coordinates, representing a face area assigned with an attribute, may change (move) within a shot over time. In such a situation, the coordinates may be averaged out within the shot, or the set of coordinates at the beginning, the middle, or the end of a time period the face area is displayed in the shot may be used. Alternatively, it is also possible to compare the change in all sets of the coordinates, each representing a face area with a single attribute, that changed overtime in each of the two face areas.

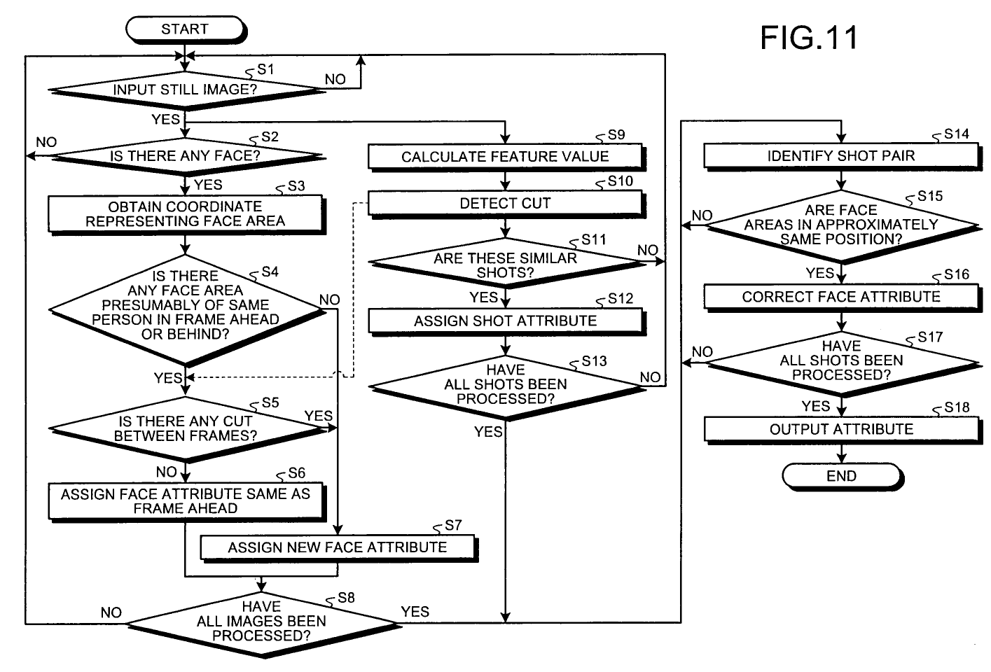

A face attribute assigning process performed by the CPU 101 in the video processing apparatus 1 will be now explained with reference to the flowchart shown in FIG. 11.

As shown in FIG. 11, when a still image is input via the video input terminal 21 (YES at step S1), the still image is sent to the face area detecting unit 11. The still image can be either a single image, such as a photograph, or one of many that make up a moving image when correlated with a playback time (a frame). The face area detecting unit 11 determines if the image has any area that is presumably the face of a person (step S2). If the face area detecting unit 11 determines that the image has an area that is presumably the face of a person (YES at step S2), the face area detecting unit 11 calculates a set of coordinates that represent the face area (step S3). If the face area detecting unit 11 determines that the image has no area that is presumably the face of a person (NO at step S2), the system control returns to the step S1, and waits for an input of the next still image.

If the still image to be detected has a face area and the input still image is one of the images making up a moving image (that is a frame), the face attribute assigning unit 12 keeps track of the coordinates of the face area, detected by the face area detecting unit 11 in that frame, a frame ahead, and a frame behind to see whether the coordinates can be considered identical, that is, the difference thereof is within a predetermined error range (step S4).

If the face attribute assigning unit 12 finds a pair of face areas that are presumably the same person from the frame ahead or the frame behind (YES at step S4) and, at the same time, there is no cut point sent from the cut detecting unit 14 (see step S10 to be described later) between the two frames to be tracked (NO at step S5), the face attribute assigning unit 12 assigns the same face attribute (ID) to that pair of face areas (step S6).

If the face attribute assigning unit 12 does not find a pair of face areas that are presumably of the same person from the frame ahead or the frame behind (NO at step S4), or if the face attribute assigning unit 12 finds a pair of face areas that are presumably of the same person from the frame ahead or the frame behind (YES at step S4) but there is a cut point sent from the cut detecting unit 14 between the two frames to be tracked (YES at step S5), the face attribute assigning unit 12 stops tracking the face areas. The face attribute assigning unit 12 determines that these two frames does not any pair of face area that should be assigned with a same attribute, and assigns new face attributes (IDs) to these face areas (step S7).

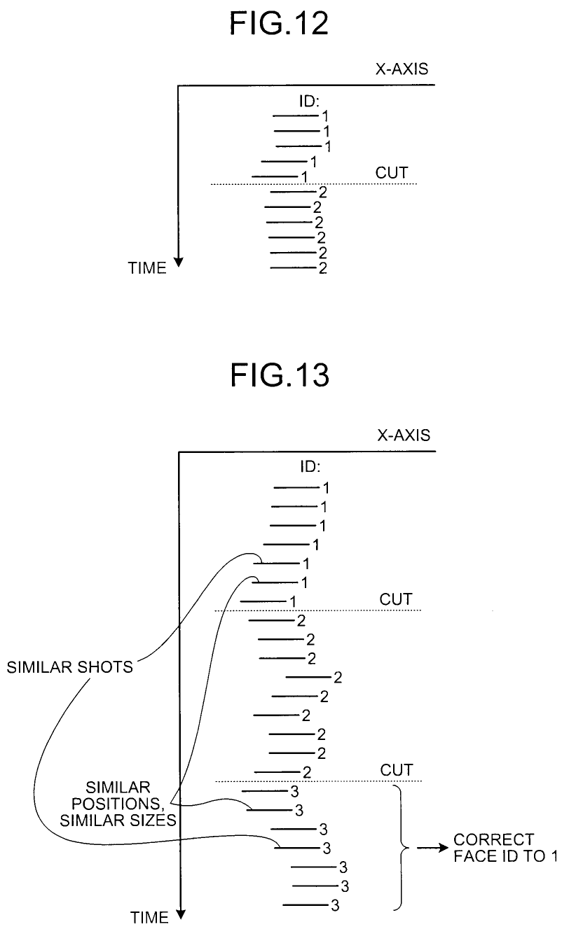

FIG. 12 is a diagram of an example how face attributes (IDs) are assigned to the face areas if there is a cut point between the two tracked frames. As shown in FIG. 12, a new face attribute (ID) is assigned to the face areas in the frame subsequent to the cut point sent from the cut detecting unit 14.

The steps S2 to S7 are repeated until all the images (frames of a moving image) are processed (YES at step S8).

When the still image (the single frame) is input to the video input terminal 21 (YES at step S1), the input still image is also sent to the feature value calculating unit 13. The feature value calculating unit 13 calculates a feature value of the frame input via the video input terminal 21 without an understanding process of the content structure thereof (e.g., detecting a face or an object) (step S9) so that the calculated amount can be used for detecting a cut and for detecting similar shots to be described later. The cut detecting unit 14 detects a cut using the feature value of the frame that is calculated by the feature value calculating unit 13 (step S10).

After the cut detection unit 14 segments the shots along the timeline, the similar shot detecting units 15 detects similar shots (step S11). If any similar shots are detected (YES at step S11), the similar shot detecting unit 15 assigns a shot attribute (ID) to the shots that are determined to be similar (step S12). If no similar shots are detected (NO at step S11), the system control returns to the step S1, and waits for an input of the next still image.

The steps S9 to S12 are repeated until all the images (frames of a moving image) are processed (YES at step S13).

In these steps, if the faces of the same people in the video have the same characteristics because they are temporally continuing, these faces, as sets of coordinates of face area, are assigned with the same face attributes. For the video itself, each shot, segmented by the cut detection, is assigned with a shot attribute, and similar shots, if any, are assigned with the same shot attribute.

Subsequently, the face attribute re-assigning unit 16 determines if any face areas assigned with different face attributes in different shots should be considered to be the face of a same person. Specifically, the face attribute re-assigning unit 16 finds a given pair of shots, that is, a pair of similar shots according to this embodiment (step S14), compares the sets of coordinates of face areas present in these similar shots, and determines if any face areas of similar sizes are detected at approximately the same position of these two similar shots (step S15).

If one of the two compared similar shots does not have a face area, or if face areas of similar sizes are not detected in approximately the same position of the two compared similar shots (NO at step S15), the system control returns to the step S14 and finds the next pair of similar shots.

If face areas of similar sizes are detected in approximately the same position of the two compared similar shots (YES at step S15), the face attributes assigned to these face areas are corrected to so to assign the same attribute to these face areas (step S16). FIG. 13 is a diagram of an example how face attributes are corrected.

The steps S14 to S16 are repeated until all of the similar shots in the entire video are processed (YES at step S17).

The CPU 101 outputs the integrated and corrected attributes to an attribute information output terminal 22 (step S18).

The face area detecting unit 11, the face attribute assigning unit 12, the feature value calculating unit 13, the cut detecting unit 14, the similar shot detecting unit 15, and the face attribute re-assigning unit 16 accumulate and exchange information using a primary storage device such as the RAM 103 or the HDD 104. Such information includes information input from a unit prior to another and needs temporary storage, information output to the following unit, or processed or in-process information that need to be kept because data process requires going back thereto.

According to this embodiment, if the difference between the feature values of frames from different shots is within a predetermined error range, one or more additional frames are selected from the shots, and the feature values thereof are calculated based on the face area included therein. If the difference between the feature values of the selected frames is within a predetermined error range, the shots, including the frames determined to be similar, are also determined to be similar and assigned with the same shot attribute. In this manner, even if a person moves or a camera work is changed, such as by zooming in, between the frames, whose image feature values are to be compared, the feature values can be detected correctly as long as the shots are taken from the same camera angle. The accuracy of similar shot detections can be improved in this manner, enabling shot clustering based on the similar shot detection, and improvement in the automatic segmenting feature provided in a program recoding apparatus.

According to the embodiment, the face area attributes are re-assigned from the first shot and thereafter in a moving image after the face detection is completed for all of the frames in the moving image, and after the similar shot detection is completed for all of the shots. However, the present invention is not limited to this embodiment. For example, a given amount of input images and processed results can be buffered, and the accumulated images can be performed of “face detection and face tracking”, “cut detection and similar shot detection”, and “re-assignment of the face area attribute using the results thereof”. With this arrangement, immediately after the input of video completes, or soon after thereof, the entire process can be finished for that moving image.

In a variation of this embodiment, the cut detection and the face area tracking may also be omitted. Such process can be realized as the same process if the entire moving image is considered to include shots with only one frame.

Furthermore, in another variation of the embodiment, the input images could be those that do not have to be temporally consecutive, such as photographs, not a part of a moving image. This variation can be also realized, in the same manner as the variation without the cut detection and face area tracking, if each of the images is considered to be a shot. For example, to provide a mapping between the faces, which are the subjects in two photographs, so to determine these faces are those of the same person, it is determined if the feature values, extracted from the entire images, are similar (in other words, equivalent to being similar shots). If similar, the coordinate sets representing face areas present in each of the images are compared. If a pair of close face areas are found, these face areas are assigned with the same face area attribute. In other words, these faces can be presumed to be of the same person. This method can be used to map face images between a plurality of photographs that are taken several times to make sure that the facial expressions of the subjects are satisfying.

Still furthermore, in the embodiment, the face attribute assigning unit 12 is enabled in the process. However, the effects can be achieved, though limited, with the face attribute assigning unit 12 disabled, or even without the presence thereof. However, if the face attribute assigning unit 12 is provided and enabled, the accuracy of similarity calculation can be improved, for example, in the manner explained below. The frame selecting unit 31 selects equal or more than two frames from two shots, and similar shots are detected using a plurality of pairs of frames. Upon detecting the similar shots, the face attribute assigning unit 12 functions to make a correlation between the face areas that are determined to be the face of the same person between the shots, and weight can be given in a varying manner to the similarity calculation that is performed based on the face areas.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A similar shot detecting apparatus for a video component comprising:
a frame selecting unit that selects one or more target frames from each of shots that are aggregates of frames within a time period divided by a cut point corresponding to a switching of video shooting within the temporally consecutive frames, when a difference between feature values of the target frames is within a predetermined error range;
a feature value calculating unit for detecting similar shots that calculates a feature value of each of the target frames, based on face areas within each of the target frames;
a feature value comparing unit that compares the feature value for each of the target frames calculated by the feature value calculating unit; and
a shot attribute assigning unit that assigns a same shot attribute to each of the shots from which the target frames determined to be similar are retrieved, thereby making each of the shots as a similar shot, when a difference between the feature values of the target frames is within a predetermined error range.

2. The apparatus according to claim 1, wherein
the feature value calculating unit sets a set of coordinates representing the face areas in the target frames as a part of the feature value of the target frames, and adds the part of the feature value to an image feature value calculated based on all of the target frames.

3. The apparatus according to claim 1, wherein
the feature value calculating unit sets a set of coordinates representing the face areas in the target frames as a feature value of the target frames.

4. The apparatus according to claim 1, wherein
the feature value calculating unit includes a feature value calculation-area determining unit that determines a feature value calculating area in the target frames based on the face areas; and
the feature value calculating unit calculates a feature value of the target frames from the feature value calculating area.

5. The apparatus according to claim 4, wherein
the feature value calculation-area determining unit sets as each of the feature value calculating area, an area extended by a given magnification ratio from the set of coordinates representing the face areas in each of the target frames whose similarities are to be determined.

6. The apparatus according to claim 4, wherein
the feature value calculation-area determining unit generates person areas each of which is an image area presumed to include a person from the set of coordinates representing the face areas in the respective target frames whose similarities are to be determined, and sets an area obtained by subtracting an area combined by each of the person areas from the respective target frames, as the feature value calculating area.

7. A computer program product having a computer readable medium including programmed instructions for detecting similar shots within a video component, wherein the instructions, when executed by a computer, cause the computer to perform:
selecting one or more target frames from each of shots that are aggregates of frames within a time period divided by a cut point corresponding to a switching of video shooting within the temporally consecutive frames, when a difference between feature values of the target frames is within a predetermined error range;
calculating a feature value of each of the target frames based on face areas within each of the target frames;
comparing the feature value for each of the target frames; and
assigning a same shot attribute to each of the shots from which the target frames determined to be similar are retrieved, when a difference between the feature values of the target frames is within a predetermined error range.

8. A similar shot within a video component detecting method comprising:
selecting one or more target frames from each of shots that are aggregates of frames within a time period divided by a cut point corresponding to a switching of video shooting within the temporally consecutive frames, when a difference between feature values of the target frames is within a predetermined error range;
calculating a feature value of each of the target frames based on face areas within each of the target frames;
comparing the feature value for each of the target frames; and
assigning a same shot attribute to each of the shots from which the target frames determined to be similar are retrieved, when a difference between the feature values of the target frames is within a predetermined error range.
